(19) United States
(12) Patent Application Publication
(10) Pub. No.: US 2017/0210220 A1
(43) Pub. Date: Jul. 27, 2017

(54) TRACTION SYSTEM FOR VEHICLE

(71) Applicants: DENSO International America, Inc, Southfield, MI (US); THE REGENTS OF THE UNIVERSITY OF MICHIGAN, Ann Arbor, MI (US)

(72) Inventors: Zifu WANG, Farmington Hills, MI (US); Jeff C. WHITE, Windsor (CA); Heath HOFMANN, Ann Arbor, MI (US)

(21) Appl. No.: 15/002,557

(22) Filed: Jan. 21, 2016

(51) Int. Cl. B60K 7/00; H02K 7/08; B60L 7/10; H02K 1/12; H02K 1/27; H02K 11/33

(52) U.S. Cl. CPC B60K 7/0007; H02K 1/2793; H02K 11/33; B60L 7/10; H02K 1/12; H02K 7/08; B60K 2007/0092

(57) ABSTRACT

A traction system for a vehicle may include a first mount, a second mount, a stator, and a rotor. The first mount defines a hollow core. The second mount is coaxially positioned with the first mount about a center axis. The stator is attached to and arranged along an outer surface of the first mount. The rotor is attached to and arranged along an inner surface of the second mount. The rotor faces the stator and rotates with respect to the stator and about the center axis.

### FIELD

The present disclosure relates to a traction system for a vehicle and, more particularly, to traction systems including a motor incorporated in a wheel.

### BACKGROUND

This section provides background information related to the present disclosure which is not necessarily prior art.

Electric and/or hybrid vehicles may use electric motors for controlling traction of the vehicle. These electric motors may be positioned within a body of the vehicle or directly in the wheels (i.e., in-wheel motors).

In-wheel motors can reduce the size of the motor and free-up space in the vehicle body. More particularly, in lieu of having the electric motors in the vehicle body, electrical components that are generally part of the motor, such as the rotor, the stator, and the power electronics, are moved to the wheel. By transferring the electric motor to the wheel, the overall weight of the wheel or, in other words, an un-sprung portion of the vehicle, increases. Such an increase in weight may adversely affect the handling of the vehicle.

### SUMMARY

This section provides a general summary of the disclosure, and is not a comprehensive disclosure of its full scope or all of its features.

The present disclosure is directed toward a traction system for a vehicle. The traction system may comprise a wheel that includes a tire and a motor. The motor includes a rim, a support mount, a stator, a rotor, and power electronics. The tire may be arranged along an outer surface of the rim. The support mount defines a hollow center, and the support mount is coaxially positioned with the rim about a rotational axis of the wheel.

The stator may be attached to and arranged along an outer surface of the support mount. The rotor may be attached to and arranged along an inner surface of the rim. The rotor faces the stator with an air gap defined between the stator and the rotor. The rotor rotates with respect to the stator about the rotational axis. The power electronics are electrically coupled to the stator for transferring power between a power source and the stator.

The traction system of the present disclosure includes a motor positioned within the wheel. The hollow core provided by the motor may reduce the weight of the un-sprung portion of the vehicle and, therefore, may improve the handling of the system.

Further areas of applicability will become apparent from the description provided herein. The description and specific examples in this summary are intended for purposes of illustration only, and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a traction system of the present disclosure;

FIG. 2 is a cross-sectional view of the traction system of FIG. 1 taken along line 2-2; and

FIG. 3 is a functional block diagram of the traction system having an AC motor and power electronics.

Corresponding reference numerals indicate corresponding parts throughout the several views of the drawings.

### DETAILED DESCRIPTION

In-wheel motors transfer an electric motor from a vehicle body to a wheel of the vehicle to provide a more compact traction system. Some in-wheel motors utilize a hub assembly of a wheel for supporting the electric motor. However, by having the additional components of the electric motor and the hub assembly, the weight of the wheel may increase and, as a result, may affect the handling performance of the vehicle.

A traction system of the present disclosure includes an in-wheel motor that is provided within two circular mounts that define a hollow core. By having a hollow core with no hub assembly, the weight of the in-wheel motor is reduced compared to an in-wheel motor having a hub-assembly.

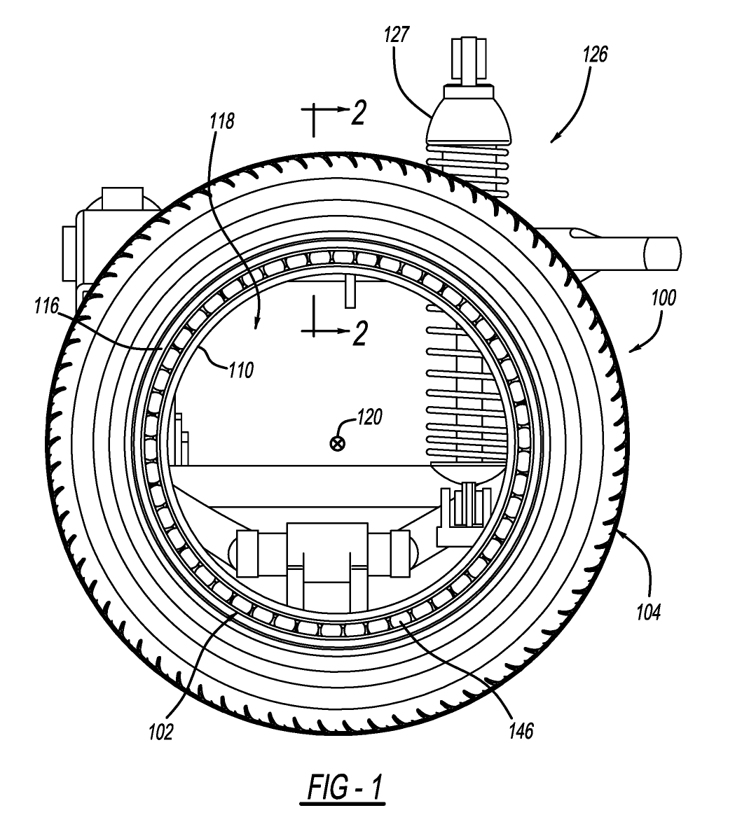

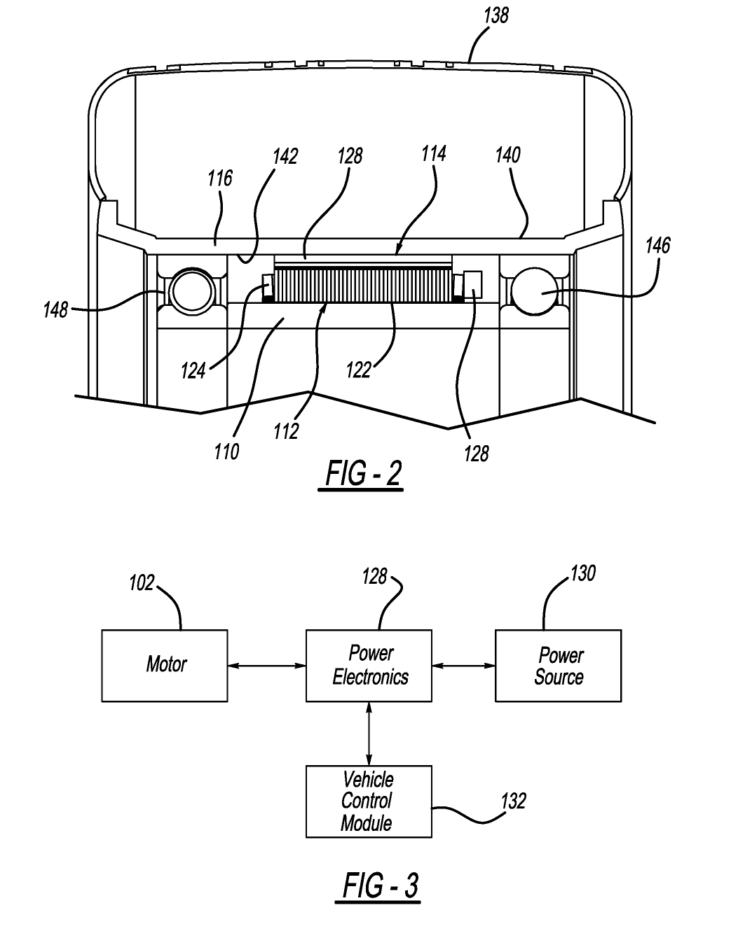

The present disclosure will now be described more fully with reference to the accompanying drawings. With reference to FIGS. 1 and 2, a traction system 100 for a vehicle, such as a hybrid/electric driven vehicle, includes a hub-less wheel with an integrated motor. More particularly, the traction system 100 includes a motor 102 integrated within a wheel 104 and is operable to rotate the wheel for moving the vehicle. The motor 102 may also be operated as a generator for supplying power to a power source as part of a regenerative breaking operation.

In the example embodiment, the motor 102 is an AC motor that receives power from a power source, such as a battery, disposed in the vehicle body. The motor 102 includes a support mount 110, a stator 112, a rotor 114, and a rotor mount 116. The support mount 110 has a cylindrical body and defines a hollow center 118. The support mount 110 is coaxially arranged with the rotor mount 116 about a rotational axis 120 (i.e., a center axis) of the wheel 104. The support mount 110 may be made of steel or other suitable material.

The stator 112 is coupled to and circumferentially extends along an outer surface of the support mount 110. The stator 112 includes an electromagnetic core 122 and coils 124 wrapped around the electromagnetic core 122. The stator 112 forms magnetic poles when energized with current. The magnetic core 122 may be formed using magnetic material, such as electrical steel or amorphous metal.

The stator 112 and the support mount 110 are stationary with respect to the rotational axis 120. The support mount 110 is connected to a suspension system 126 of the vehicle. The suspension system 126 includes a shock absorber 127 that dampens the relative motion of the suspension system 126 and the body of the vehicle.

The motor 102 includes one or more power electronics 128 that provide power to the stator 112. In the example embodiment the power electronics 128 are disposed with the stator 112. Alternatively, the power electronics 128 may be disposed outside of the wheel 104 within the vehicle body, and the stator 112 receives the current through cables extending between the power electronics 128 and the stator 112. The connection between the power electronics 128 and the coils 124 can be configured in different forms. For example, either delta or star connection can be applied. Moreover, a plurality of three-phase connections can be used in order to allow additional features of the motor performance control.

With reference to FIG. 3, the power electronics 128 receive and/or provide power from/to a power source 130, such as a battery. More particularly, the power electronics 128 convert DC power from the power source 130 to AC power (i.e., high alternating current) that is provided to the coils 124 of the stator 112 during a drive operation of the vehicle. The power electronics 128 may also operate to convert AC power from the motor 102 to DC power that is supplied to the power source 130 during regenerative braking. Accordingly, the power electronics 128 operate as an inverter and a rectifier and, therefore, may include various semiconductor components, such as transistors and diodes, for converting power between AC and DC.

The power electronics 128 are controlled by a vehicle control module 132. More particularly, based on various inputs, such as acceleration, deceleration, current vehicle speed, etc., the vehicle control module 132 may operate the power electronics 128 to supply power to the motor 102 or to receive power from the motor 102, for charging the power source 130 as part of a regenerative braking system. The vehicle control module 132 is positioned within the vehicle body, such as behind the instrument panel of the vehicle or other suitable location.

With continuing reference to FIGS. 1 and 2, the rotor mount 116 has a cylindrical body. A tire 138 is mounted along an outer surface 140 of the rotor mount 116. Accordingly, the rotor mount 116 may be considered a rim of the wheel 104.

The rotor 114 is positioned at and circumferentially extends along an inner surface 142 of the rotor mount 116. The rotor 114 faces the stator 112 with an air gap provided between the rotor 114 and the stator 112. Accordingly, the rotor 114 and the stator 112 are positioned between the support mount 110 and the rotor mount 116.

The rotor 114 includes multiple magnets 139 mounted along the inner surface 142 of the rotor mount 116. In an exemplary embodiment, the rotor mount 116 is made of magnetic material. The rotor mount 116 may be made of another material, and is not limited to a magnetic material.

The support mount 110 having the stator 112 and the rotor mount 116 are connected to each other by way of multiple ball bearings 146 disposed on either side of the stator 112 and the rotor 114 and between the support mount 110 and the rotor mount 116. Seals 148 are positioned next to the bearings 146 to prevent debris from entering between the rotor 114 and the stator 112.

The rotor 114 rotates about the rotational axis 120 of the wheel 104 and rotates at the same rotational speed as the tire 138. More particularly, in operation, the power electronics 128 supply alternating current to the stator 112 to generate the electromagnetic field for rotating the rotor 114 with respect to the stator 112. As the rotor 114 rotates, the wheel 104 rotates. To increase the rotational speed of the rotor 114, the power electronics 128 may increase the power provided to the stator 112. Conversely, to reduce the rotational speed of the rotor 114, the power electronics 128 reduce or stop the supplying power to the stator 112. At this time, the motor 102 may also operate as a generator to convert kinetic energy to electrical power, as part of the regenerative braking operation, and the electrical power is supplied to the power source 130 via the power electronics 128. In the example embodiment, the motor is illustrated with a permanent magnet based rotor. Alternatively, the motor may be provided with squirrel-cage rotor for an induction motor concept.

The traction system 100 of the present disclosure reduces the un- sprung weight of the wheel 104 using a centerless structure. In particular, the wheel of a conventional vehicle may include spokes that extend from a central hub to the interior surface of the rim of the wheel. The central hub may include other components, such as bearings or a brake system.

The traction system 100 includes the wheel 104 which does not have spokes and/or a central hub. More particularly, by constructing the motor 102 within the rotor mount 116 (i.e., the rim) and the support mount 110, the spokes and central hub are no longer required. Specifically, the power electronics of the motor 102 may be provided along with the stator 112 or within the vehicle body. Furthermore, the stator 112 is placed at the interior of the rotor within the support mount 110, and the rotor 114 is positioned at the interior surface of the rim and rotates at the same speed as the wheel.

Furthermore, in the example embodiment, ball bearings are used to support and align the rotor and the stator. Alternatively, magnetic bearings may be used to support the wheel with the motor using magnetic levitation in which the magnetic bearings support the rotor and the stator and allow rotation of the rotor without physical contact between the two parts.

The foregoing description of the embodiments has been provided for purposes of illustration and description. It is not intended to be exhaustive or to limit the disclosure. Individual elements or features of a particular embodiment are generally not limited to that particular embodiment but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

What is claimed is:

1. A traction system for a vehicle, the traction system comprising:
a first mount defining a hollow core;
a second mount coaxially positioned with the first mount about a center axis, wherein the second mount is positioned along an outer surface of the first mount;
a stator attached to the outer surface of the first mount; and
a rotor attached to an inner surface of the second mount, wherein the rotor faces the stator and rotates with respect to the stator and about the center axis.

2. The traction system of claim 1 further comprising:
power electronics electrically coupled to the stator.

3. The traction system of claim 1 further comprising:
a tire positioned along the outer surface of the second mount.

4. The traction system of claim 1 wherein the first mount is attached to a suspension system of the vehicle.

5. The traction system of claim 1 further comprising:
a plurality of bearings positioned between the rotor and the stator to align and support the rotor and the stator.

6. The traction system of claim 1 wherein:
the stator includes a coil wrapped around the stator, and
the rotor includes magnets circumferentially positioned along the second mount.

7. The traction system of claim 1 wherein the stator and the rotor are operable as a generator to supply power to a power source disposed in the vehicle and as a motor to convert power from the power source to kinetic energy to move the vehicle.

8. A traction system for a vehicle that includes a battery, the traction system comprising:
a wheel including a tire; and
a motor arranged within the wheel and comprising a rim, a support mount, a stator, a rotor, and power electronics, wherein:
the support mount defines a hollow center and is coaxially positioned with the rim about a rotational axis,
the stator is attached to and arranged along an outer surface of the support mount,
the rotor is attached to and arranged along an inner surface of the rim, the rotor faces the stator with an air gap defined between the stator and the rotor, and rotates with respect to the stator and about the rotational axis, and
the power electronics are electrically coupled to the stator for supplying power from a power source to the stator.

9. The traction system of claim 8 further comprising:
a plurality of bearings positioned between the rotor and the stator, wherein the plurality of bearings are arranged circumferentially between the rim and the support mount on either side of the rotor and the stator.

10. The traction system of claim 9 wherein the plurality of bearings are ball bearings.

11. The traction system of claim 9 wherein the plurality of bearings are magnetic based bearings.

12. The traction system of claim 8 wherein the support mount is attached to a suspension system of the vehicle.

13. The traction system of claim 8 wherein the stator and the rotor operate as a generator to supply power the power source by way of the power electronics.

14. The traction system of claim 8 wherein:
the stator includes a magnetic core and coil wrapped around the magnetic core, the magnetic core and the coil circumferentially extend around the support mount, and the power source provides current to the coil by way of the power electronics, and
the rotor includes a plurality of magnets that are arranged circumferentially about the rim.

15. The traction system of claim 8 wherein the power electronics are arranged with the stator.

16. The traction system of claim 8 wherein the power electronics are arranged in a body of the vehicle outside of the stator.

17. A traction system for a vehicle, the traction system comprising:
a support mount defining a hollow core and having a cylindrical shape, wherein the support mount is connected to a suspension system of the vehicle;
a rim coaxially positioned with the support mount about a rotational axis, wherein the rim is positioned around the support mount;
a tire arranged along an outer surface of the rim; and
a motor positioned between the support mount and the rim, wherein:
the motor includes a stator arranged along an outer surface of the support mount, a rotor arranged along an inner surface of the support mount, and a plurality of power electronics positioned with the stator, and
the rotor, the rim, and the tire rotate about the rotational axis when the vehicle is traveling, and the stator, the power electronics, and the support mount are stationary.

18. The traction system of claim 17 further comprising:
a plurality of bearings positioned between the rotor and the stator, wherein the plurality of bearings are arranged circumferentially between the rim and the support mount on either side of the rotor and the stator.
